(19) United States
(12) Patent Application Publication
(10) Pub. No.: US 2017/0202163 A1
(43) Pub. Date: Jul. 20, 2017

(54) AEROPONIC CULTURE LINE

(71) Applicant: Combagro (Suisse) Sarl, Molondin (CH)

(72) Inventors: Raymond Aschheim, Molondin (CH); Benoit de Combaud, Saint Cierges (CH); Roland Fasel, Cremines (CH); Andreas Muller, Prilly (CH); Raphael Sandoz, Molondin (CH)

(21) Appl. No.: 15/317,381

(22) PCT Filed: Jun. 10, 2015
(86) PCT No.: PCT/EP2015/062974

§ 371 Date: Jan. 20, 2017

(30) Foreign Application Priority Data
Jun. 10, 2014 (FR) 1455232

(51) Int. Cl. A01G 31/04; A01G 31/02

(52) U.S. Cl. CPC A01G 31/042; A01G 31/02; A01G 2031/005

(57) ABSTRACT

The disclosure relates to an aeroponic culture line comprising a surface for separating the follicular space and radicular space, provided with openings for receiving porous culture supports and spray means arranged on the radicular side of the surface. The spray means are designed to produce a spray area that is smaller than 10% of the total area of the separation surface, the spray means being mounted on a carriage that can move in parallel to the separation surface, on the radicular side, in order to periodically cover all of the area of the surface provided with culture supports.

### CROSS-REFERENCE TO RELATED APPLICATIONS

This application is a national phase entry under 35 U.S.C. §371 of International Patent Application PCT/EP2015/062974, filed Jun. 10, 2015, designating the United States of America and published as International Patent Publication WO 2015/189292 A1 on Dec. 17, 2015, which claims the benefit under Article 8 of the Patent Cooperation Treaty to French Patent Application Serial No. 1455232, filed Jun. 10, 2014, the contents of each of which are incorporated herein in their entirety by this reference.

### TECHNICAL FIELD

This disclosure relates to the field of aeroponics culture.

In the field of aeroponics, the functions of support and supply with water and nutrients, usually provided by the soil, are fulfilled by “plant holders,” i.e., usually a porous block made of plastic material, and by continuously spraying the roots with mists of mineral salts-based nutrient solutions rotating in a closed loop by means of a pump. 100% water availability and 100% air availability are thus obtained, which explains the growth performances.

This technique can be compared to its forerunner, i.e., hydroponics, except that hydroponics plants grow on an inert substrate (such as, pozzolan or pumice stone), irrigated at regular intervals and fed by regular intake of a nutrient solution.

In aeroponics, all the parameters of the nutrient medium (nutrients concentration and their respective proportion, pH, temperature, etc.) can be controlled to get the best cultivation results.

When rationally applied, this technique makes it possible to obtain a substantial quantitative and qualitative increase in productivity, a significant reduction in labor, fertilizers and water, and, specifically, a significant reduction in energy consumption of greenhouse crops.

### BACKGROUND

Various solutions for making aeroponics facilities are known in the prior art.

The patent EP 2644025 describes an exemplary movable aeroponic growth unit for growing plants, and an improved system for aeroponically growing plants.

The patent WO 2013/136014 discloses another exemplary aeroponic equipment comprising a plurality of substrate blocks intended to receive at least one seed and to maintain the plant during its entire growth. The substrate block dimensions are fixed and so determined as to enable the growth of vegetation on one side and of roots on the other side, and the cross-section of the substrate block ranges from 1.2 to 10 times the nominal cross-section of the crown of the adult plant. Movable supports are provided with recesses for receiving substrate blocks moving in a transverse movement, with the equipment comprising means for changing the spacing of consecutive substrate blocks in the course of the growth of the plant. Such recesses are open at the top to enable the passage of vegetation and at the bottom to let the roots through.

Another example of potato seeds aeroponics facilities is described in the patent CN202773643. This patent discloses a spray time-delay control device comprising a circulation system for the nutrient solution and a plurality of plant-cultivating beds, wherein each plant-cultivating bed comprises a water tank, an oblique bed panel. The nutrient solution circulation system comprises a water box, a water supply pipe and a water return pipe, a circulation pump controlled by the time-delay spray controller is mounted on the water supply line and the atomization chambers.

### Disadvantages of the Prior Art Solutions

These various solutions are generally adapted to fast-growing plant varieties, such as potato seeds, enabling a few days' production cycles and a frequent turnover of production launching.

Such solutions are unsuitable for crops, which require longer times, e.g., salads, the growth cycle of which amounts to a few weeks (about 7 weeks). As a matter of fact, the cost of manufacture, installation and operation of such facilities is relatively high, and to be properly amortized, it is desirable to concentrate the use in time and in space.

For slower crops, the installation is immobilized for a long period. Besides, some species, such as salads, produce abundant follicular vegetation, which occupies a large space and requires significant spacing between two consecutive culture supports, at least when plants are almost ripe.

Another solution is proposed by the American patent application US 2009/293357 that provides for an apparatus and a method for delivering fine spray of air and nutrient-rich liquid to the root area of developing plants with a shaped nozzle end for controlling and varying the dimensions and shape of the delivered fog, and capable of providing a droplet size of between 30 and 80 microns, and not below 5 microns.

This patent US 2009/293357 discloses that droplets below 30 microns in size contain little water and must be supplied in such big quantities that they saturate air with water and do not enable adequate oxygenation although using aeroponics. It also explains that droplets above 100 microns in size stay too long on the plant and prevent optimal oxygenation too, and that, in this case, the systems must be turned off and on regularly, which is detrimental to pumps.

### BRIEF SUMMARY

In order to remedy such drawbacks, the disclosure in its broadest sense relates to an aeroponic culture line comprising a surface for separating the follicular space and the radicular space, provided with openings for receiving porous culture supports and spray means arranged on the radicular side of the surface, wherein the spray means are designed to produce a spray area that is smaller than 10% of the total area of the separation surface, with the spray means being mounted on a carriage that can move in parallel to the separation surface, on the radicular side, in order to periodically cover all of the area of the surface provided with culture supports.

The fact that the carriage moves and sprinkles only one particular plant for less than one tenth of the time, without requiring the pump to be turned off and on very often, specifically solves the problem raised in the patent US 2009/293357, while maintaining a greater flexibility in the calibration of droplets.

The separation surface advantageously consists of a strip having a plurality of openings for positioning individual culture blocks.

The separation surface is preferably movable to ensure the displacement of the openings receiving the culture supports between a loading end and a harvesting end.

The culture supports preferably consist of blocks made of a porous material.

According to an advantageous embodiment, the separation surface is horizontal and longitudinally extends above the guide rail of a carriage that can move longitudinally, with the spray means provided on the carriage being supplied by a conduit connecting a source of liquid nutrient to the carriage.

The separation surface is advantageously horizontal and longitudinally extends above the guide rail of a carriage that can move longitudinally, and comprises a liquid nutrient tank.

The distance between the separation surface and the nozzle ejection point preferably ranges from 5 to 60 centimeters.

The culture line advantageously comprises an aeroponic spraying system consisting of a generator of a liquid nutrient solution under a pressure between 2 and 30 bar, preferably between 6 and 30 bar, and spray nozzles producing droplets, the section of which ranges from 30 to 120 microns, preferably from 30 to 80 micron.

The line also advantageously comprises means for automatically replacing the pressurized nutrient solution with tap water at mains pressure (about 2 bar), in the same spray nozzles, which then produce droplets with a cross-section of about 120 microns. This backup system ensures an almost permanent irrigation even in case of a pump failure, or a lack of components for the nutrient solution.

Advantageously, the irrigation carriage control computer obtains information from various sensors on the correct operation of the mechanical and irrigation subsystems, and can specifically detect the switching to degraded mode, maintain an events and actions log and send alarms to the persons in charge of monitoring the greenhouse via SMS or the Internet. It can also adapt the carriage passage rate and speed to the environment, e.g., brightness.

A failure of the irrigation station during the night thus results in a switching to low pressure water without nutrient, and results in maintenance in the morning, but provides sufficient wetting of the plant for the night.

The system according to the disclosure advantageously offers great flexibility in irrigation parameters (pressure, flow rate, time of exposure of a plant to droplets, pause time between two successive exposures, nozzle type, number of nozzles) which makes it possible to easily reach optimum water-air balance for the roots, with simplicity and a very competitive cost of production and even makes it possible to have different settings for different parts of the same line (e.g., for seedlings on the one hand and ripe plants on the other hand, or for different varieties).

The disclosure also relates to an aeroponic culture installation, characterized in that it comprises a plurality of such culture lines oriented in parallel directions.

The installation advantageously comprises at least two adjacent culture lines oriented in opposite directions, with the loading end of one of the adjacent lines corresponding to the harvesting end of the other culture line.

According to a preferred embodiment, the installation comprises at least two adjacent culture lines with longitudinal axes diverging between the loading ends and the harvesting ends so that the spacing between the centerlines between the adjacent lines increases between the loading end and the harvesting end.

### BRIEF DESCRIPTION OF THE DRAWINGS

This disclosure will be best understood when examining a detailed and non-restrictive exemplary embodiment, while referring to the accompanying drawings, wherein:

FIG. 1 is a schematic view of a culture line according to the disclosure; and

FIG. 2 shows a schematic view of a culture line according to the disclosure, provided with movable tables.

### DETAILED DESCRIPTION

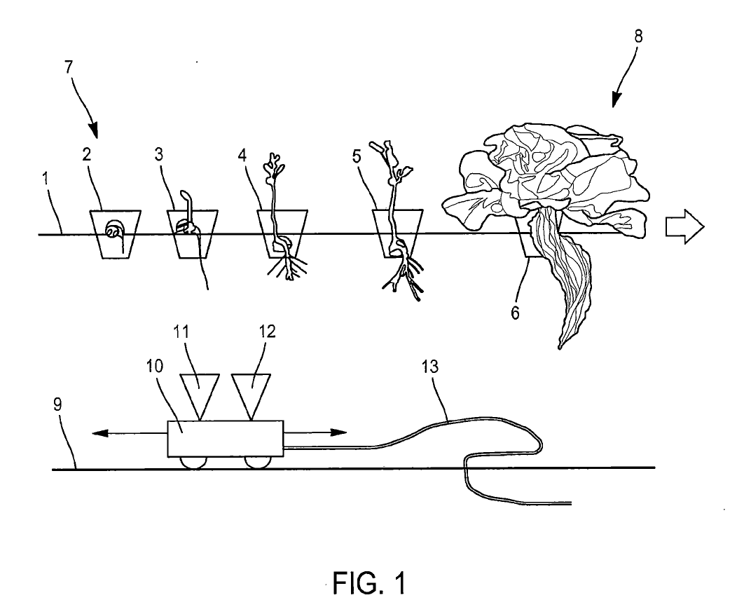

FIG. 1 shows a schematic view of a culture line comprising a conveyor belt 1 whereon culture supports 2 to 6 are mounted.

Such culture media consist of blocks of porous material gone through by precisely calibrated tiny channels so that oxygen, water and suspended particles can circulate perfectly. The substrate block dimensions are fixed and so determined as to enable the growth of vegetation on one side and of roots on the other side, and the cross-section of the substrate block ranges from 1.2 to 10 times the nominal cross-section of the crown of the adult plant.

The blocks are, for example, made of rock wool, obtained by extruding a mixture of basalt, limestone and coke melted at 1,600° C. The casting is split into a multitude of very fine fibers that, upon cooling, are bonded by a urea-formaldehyde resin and coated with a hydrophilic wetting agent. These products are specially fabricated for use as hydroponics substrate.

Rock wools are lightweight materials, characterized by a good porosity and a high water retention capacity. When in contact with the nutrient solution, rock wool releases mineral ions (calcium, magnesium, iron and manganese), which slightly alkalize the medium.

The culture media may also consist of a hollow body containing expanded clay pellets as aggregates obtained by high-temperature processing of wet clay nodules: hard, porous beads are thus obtained, which have kept the red-brown color of the original material.

The hollow body may also contain water-containing siliceous sand of volcanic origin, which is industrially expanded by a heat treatment (1,200° C.). Having a form of chemically inert white, light flakes containing 75% silica, siliceous sand is composed of silica, alumina, iron oxide, titanium oxide, lime, magnesia, sodium oxide and potassium hydroxide.

The culture blocks have a cross-section corresponding to the ports section provided in the conveyor belt 1. These may have a flange for enabling the vertical wedging thereof with respect to the strip 1.

The conveyor belt 1 moves from the feed area where the substrate 2 containing salad seed is inserted into the receiving port of the strip to a crop area where the salad has reached a ripe stage in the substrate 6.

The speed of travel along the length of the line is so determined as to feed a substrate between the supply end 7 and the harvesting end 8 in a growth cycle. For a salad, travel is typically completed in seven weeks.

The conveyor belt 1 is preferably so designed as to enable the acceleration of speed of travel between the supply end 7 and the harvesting end 8 so as to cause an increase in the distance between two consecutive substrates, between a minimum distance at the supply end 7 side and a maximum distance, substantially corresponding to the salad vegetation section, at the harvesting end 8.

The culture line also comprises rails 9 extending parallel to the longitudinal axis of the conveyor belt 1.

A movable carriage 10 moves on this rail.

The roots grow in a room protected from the light by the conveyor belt 1. They are irrigated by high pressure sprayers 11, 12, making it possible to vaporize a solution consisting of micro-droplets of a size ideally ranging from 20 to 80 μm (the optimal size for radicular exchanges) using a diaphragm pump and an expansion tank.

The aim is to maximize the radicular exchanges by vaporizing a nutrient solution for a very short time (0.5 to 1 second every 2-3 minutes) so as to maintain the presence of a fine nutrient mist with a high oxygen and minerals load in the root chamber and, therefore, to optimize the exchanges at the root hair.

The carriage 10 moves back and forth on rails 9 under the conveyor belt 1 to execute cycles of a few minutes to about one hour. The nutrient fluid is supplied through a flexible conduit 13.

Description of a Second Non Restrictive Exemplary Embodiment

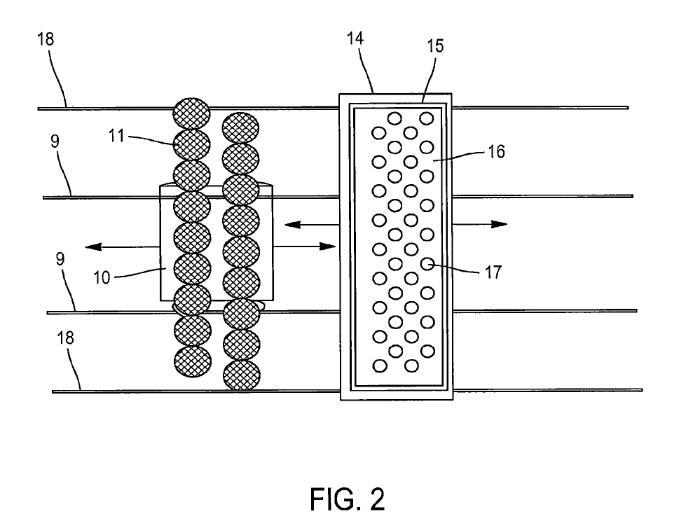

This disclosure will be better understood upon reading the description of a second exemplary detailed and restrictive embodiment, illustrated by FIG. 2.

FIG. 2 shows a schematic view of a culture line comprising an irrigation carriage 10 that can move in translation on rails 9, movable tables 14 consisting of a frame 15 containing pierced boards 16 supporting the supports 17 containing the plants, rolling on rails 18 parallel to the rails 9.

Such movable tables can be pushed by hand or by robots. Movable tables made according to the prior art to support pots can be adapted by piercing holes into the board so as to create new movable tables for aeroponics that had never been imagined in the prior art, because they are useful only when associated with the movable irrigation carriage of this disclosure.

1. An aeroponic culture line comprising a surface for separating the follicular space and the radicular space, provided with openings for receiving porous culture supports and spray means arranged on the radicular side of the surface, wherein the spray means are designed to produce a spray area that is smaller than 10% of the total area of the separation surface, with the spray means being mounted on a carriage that can move in parallel to the separation surface, on the radicular side, in order to periodically cover all of the area of the surface provided with culture supports.

2. The aeroponic culture line according to claim 1, wherein the separation surface consists of a strip having a plurality of openings for positioning individual culture blocks.

3. The aeroponic culture line according to claim 2, wherein the separation surface is movable to ensure the displacement of the openings receiving the culture supports between a loading end and a harvesting end.

4. The aeroponic culture line according to claim 2, wherein the openings comprise culture supports comprising blocks made of porous material.

5. The aeroponic culture line according to claim 1, wherein the separation surface is horizontal and longitudinally extends above the guide rail of a carriage that can move longitudinally, with the spray means provided on the carriage being supplied by a conduit connecting a source of liquid nutrient to the carriage.

6. The aeroponic culture line according to claim 1, wherein the separation surface is horizontal and longitudinally extends above the guide rail of a carriage that can move longitudinally and comprises a nutrient liquid tank.

7. The aeroponics culture line according to claim 1, wherein the separation surface and the nozzle ejection point ranges from 5 to 60 centimeters.

8. The aeroponic culture line according to claim 1, further comprising an aeroponic spraying system comprising a generator of a liquid nutrient solution under a pressure between 2 and 30 bar, and spray nozzles producing droplets, the section of which ranges from 30 to 120 micron.

9. An aeroponic culture line system, comprising a plurality of culture lines according to claim 1, the culture lines of the plurality oriented in parallel directions.

10. An aeroponic culture installation, comprising at least two adjacent culture lines according to claim 1 oriented in opposite directions, with a loading end of one of the adjacent lines corresponding to a harvesting end of the other culture line.

11. An aeroponic culture installation, in that it comprising at least two adjacent culture lines according to claim 1, with the longitudinal axes diverging between loading ends and harvesting ends of the culture lines so that the spacing between the center lines between the adjacent lines increases between the loading end and the harvesting end.

12. The aeroponic culture line according to claim 1, wherein the separation surface is movable to ensure the displacement of the openings receiving the culture supports between a loading end and a harvesting end.

13. The aeroponic culture line according to claim 1, wherein the openings comprise culture supports comprising blocks made of porous material.

14. The aeroponic culture line according to claim 3, wherein the separation surface is horizontal and longitudinally extends above the guide rail of a carriage that can move longitudinally, with the spray means provided on the carriage being supplied by a conduit connecting a source of liquid nutrient to the carriage.
